(19) United States
(12) Patent Application Publication
(10) Pub. No.: US 2018/0090870 A1
(43) Pub. Date: Mar. 29, 2018

(54) Tamper Resistant plug-able socket adapter

(71) Applicant: Laith A. Naaman, Cupertino, CA (US)

(72) Inventor: Laith A. Naaman, Cupertino, CA (US)

(21) Appl. No.: 15/711,665

(22) Filed: Sep. 21, 2017

Related U.S. Application Data
(60) Provisional application No. 62/399,577, filed on Sep. 26, 2016.

(51) Int. Cl. H01R 13/453; H01R 31/06

(52) U.S. Cl. CPC H01R 13/4534; H01R 31/06

(57) ABSTRACT

A plug-able tamper resistant socket adapter that easily plugs into a regular wall socket is disclosed. Such an adapter eliminates the need to replace and rewire existing wall sockets with tamper resistant ones. Two methods for grounding the adapter if it is plugged into ungrounded (NEMA 1) wall socket are also disclosed.

### REFERENCES CITED

U.S. PATENT DOCUMENTS

| | | |
|---|---|---|
| 4,607,136 | August 1986 | Thomas |
| 5,267,870 | December 1993 | Maresh |
| 5,391,085 | February 1995 | Tinger |
| 5,551,884 | September 1996 | Burkhart |
| 5,791,931 | August 1998 | Burkhart |
| 6,108,178 | August 2000 | Beadles |
| 6,674,003 | January 2004 | Torres |
| 7,410,377 | August 2008 | Wharton |
| 7,452,221B1 | November 2008 | Oddsen et al |
| 7,510,412B1 | March 2009 | Valantin |
| 7,645,148B2 | January 2010 | Carbone et al |
| 7,645,149B2 | January 2010 | Carbone et al |
| 7,695,293B1 | April 2010 | Sikes |
| 7,820,909B2 | October 2010 | Castalado et al |
| 8,062,072 | November 2011 | Ziobro |
| 8,242,362B2 | August 2012 | Castaldo et al |
| 8,435,055B1 | May 2013 | Bhosale |
| 8,802,979B2 | August 2014 | Ziobro |
| 8,974,239 | March 2015 | Tomimbang |
| 9,196,995B2 | November 2015 | Scanzillo |
| 9,300,120B1 | March 2016 | Clough et al |
| 20070256850A1 | November 2007 | Hansen |
| 20080248662A1 | October 2008 | Bazayev et al |
| 20090188693A1 | July 2009 | Simmons |
| 20090286411A1 | November 2009 | Bazayev et al |
| 20150372410A1 | December 2015 | Li |
| 20150380856A1 | December 2015 | Mortun et al |

### 1. Field of the Invention

The current invention relates to field of electrical adapters with receptacles on one side and a plug on the other. Such adapters are common as travel plug adapters where the receptacles are designed to accept plugs designed for one market, e.g., UK or Europe and plug into a wall socket of another market, e.g. US. The current invention plugs into a regular wall socket with or without a ground pin and turns it to a Tamper Resistant Outlet (TRO)

### 2. Background

In recent years, an increasing number of States in USA have adopted 2008NEC (National Electrical Code) standard which requires use of Tamper Proof Outlet (TRO) in new buildings. These outlets have a plastic (or other electrically insulating material) screen covering the Live and Neutral outlets to protect against children inserting metal objects in powered outlet. When a plug is inserted in a tamper resistant socket, it would push against a spring loaded mechanism that pulls the screen down thus allowing the insertion of the Live and Neutral blades. When the plug is pulled, as soon as the blades disengage from their outlets, the screen jumps back up.

Customers will have to replace their existing wall sockets with a TRO and while such sockets are not expensive, replacing existing wall sockets is not always straightforward. Customers will have to turn the power off, remove the old socket and wire the new TR socket correctly.

The prior art in this field as depicted in the patents referenced above can be divided into three categories: One the deals with design of and construction of the mechanism inside the wall socket to make it tamper resistant teaching different methods for such implementation. Not surprisingly these patents were assigned to major socket manufacturers such as Leviton and Hubble. The second category is one where the patents pertain to covers of wall sockets to make them tamper resistant. The third category is for patents pertaining to socket plug locked combination to prevent separation if the plug is yanked but prevent partial disengagement thereby exposing live conductors.

### 3. Summary of Present Invention

The invention consists of an electrical adapter with plastic or electrically insulator material body and a TRO socket on one side and a NEMA 5 or NEMA 1 plug on the other side. The blades of the NEMA 1 or 5 are electrically coupled to the corresponding receptacles of the TRO socket. When it is plugged, it covers the original wall socket and what is exposed to the user is the tamper resistant outlets. This can be done in several ways; but can be divided into two approaches; one is to design and manufacture a TRO adapter from scratch or modify the design of an existing TR socket to incorporate a plug. The other is to incorporate an off the shelf tamper resistant wall socket in making the adapter.

The former involves designing a new receptacle/plug bar parts and a new enclosure. The latter uses existing TRO wall sockets and electrically connects its terminals to the corresponding bars and pins of a plug. Such connections can be direct or using a printed circuit board or any other conducting surface. In both cases there two ways for implementation; one where both sets of pins of the plug are used which, while electrically redundant, gives the adapter better anchoring in the wall socket, or only one set and electrically connect the corresponding outlets internally.

### 4. BRIEF DESCRIPTION OF THE DRAWINGS

FIG. (1) shows the metal stamped piece of the socket inlet-plug bar. Folding part (2) 180 degrees out of the page along line (A), then its top part is folded out of the page less than 90 degrees at the base of notch (3) and along line (B) to form a lip (1). Both inlets are connected by and electrically conductive strip (7), so if either inlet is powered the other would be powered too. The plug bar is formed by folding the bottom part (5) 180 degrees out of the page onto the top part (4). The holes (6) are optional and not required by the standard.

FIG. (2) shows the resulting inlet-plug combination after folding and optionally riveting the bottom part (5) to the top part (4) with a rivet (8). The connecting strip (7) electrically connects two inlets for plug bars. FIG. (2) shows the resulting plug bar (9) and the two inlets.

FIGS. 3A and 3B show the side and top view of the connected Earth pins (10) respectively. These pins are connected by an electrically conductive metal strip (11).

FIGS. 4A and 4B show alternative implementations of the socket inlet-plug bar combination.

FIGS. 5A and 5B show a tamper resistant adapter using an off the shelf TRO socket inside an enclosure (14). FIG. 5A shows the Neutral side of TRO and Neutral terminals (12).The TRO socket (top part (13) and bottom part (19)) is screwed at the terminals of the socket at Neutral terminal (12), Earth terminal (15) and Live terminal (22) to said terminals to the corresponding pins Earth pin (16), Neutral bar (17) and Live bar (18).

FIG. (6) shows a duplex NEMA 1 (28) ungrounded wall socket with Live outlets (23) and Neutral outlets (24) and a screw (25) to attach the face plate (not shown).

FIG. (7) shows front and side views of the grounding metal piece (27) with a screw hole (26).

FIGS. 8A and 8B show front and side views of the grounding contact (28) for a NEMA 1 wall socket. FIG. (8B) shows the folding lines, D and E of the grounding piece. These grounding contacts replace the Earth pins shown in FIGS. (3A and 3B).

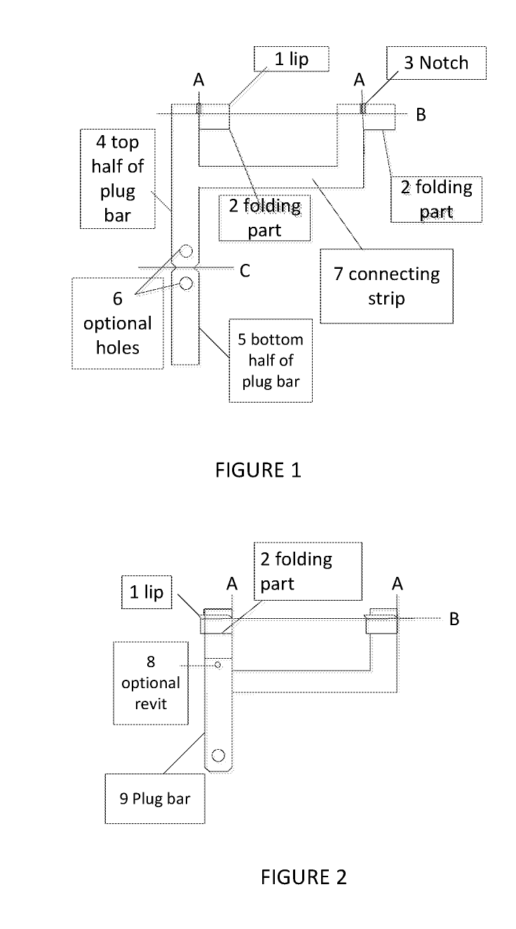

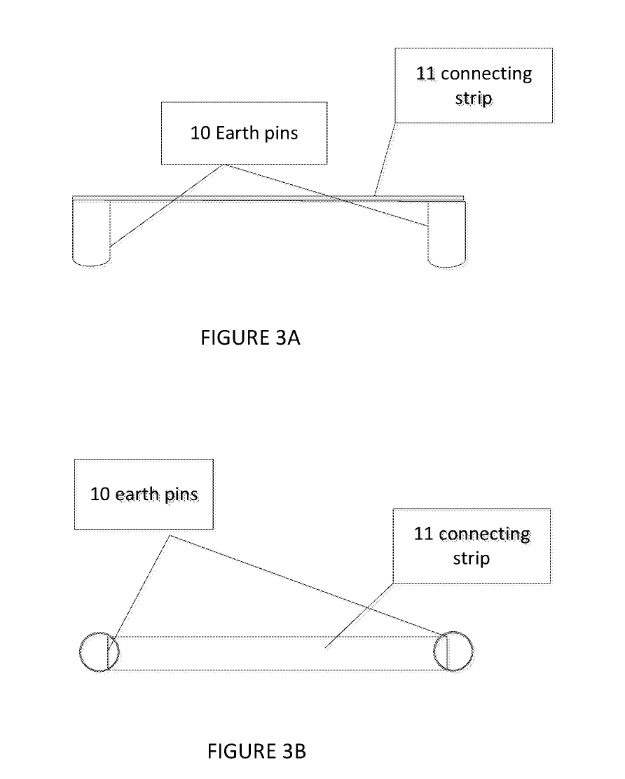

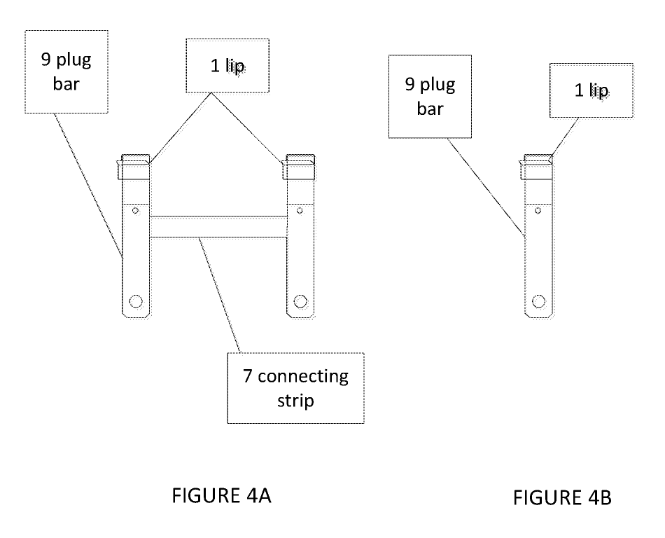

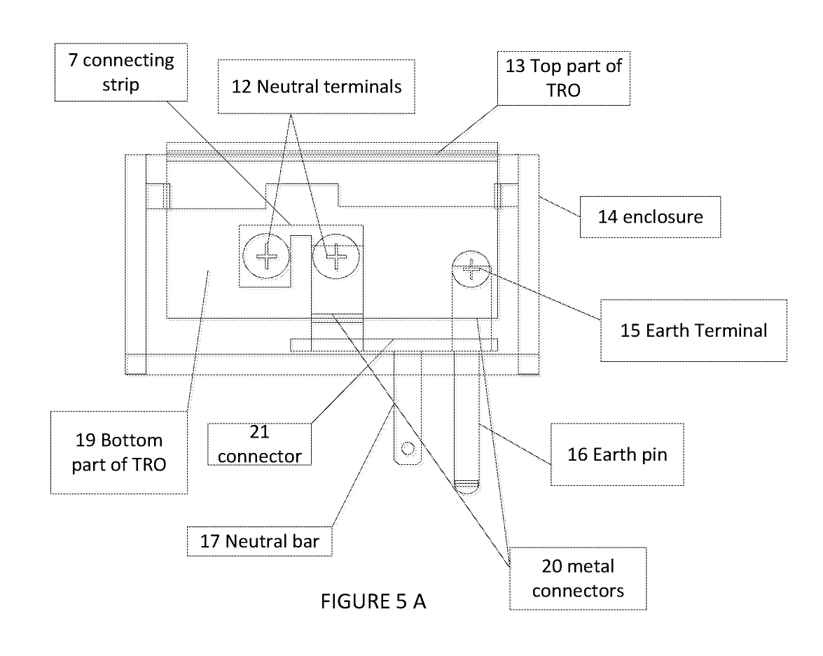

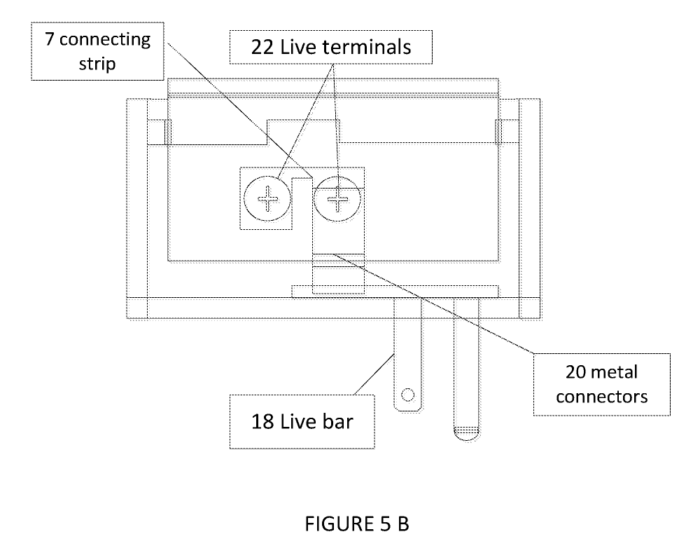

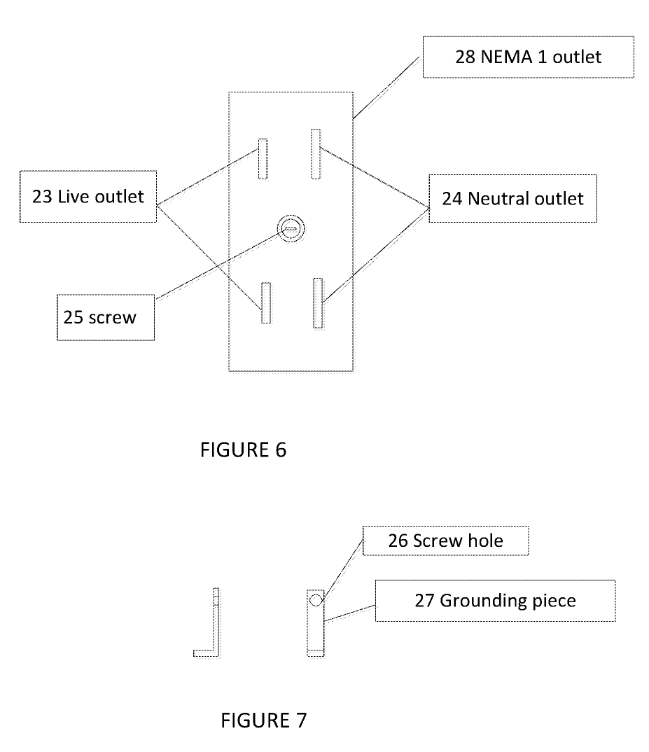

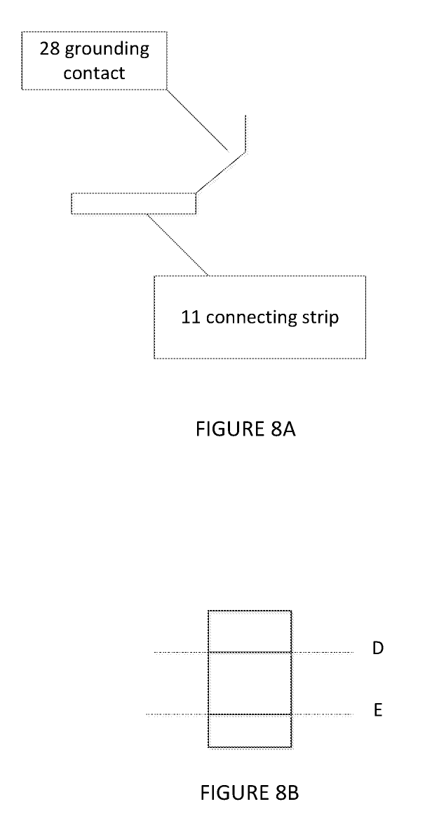

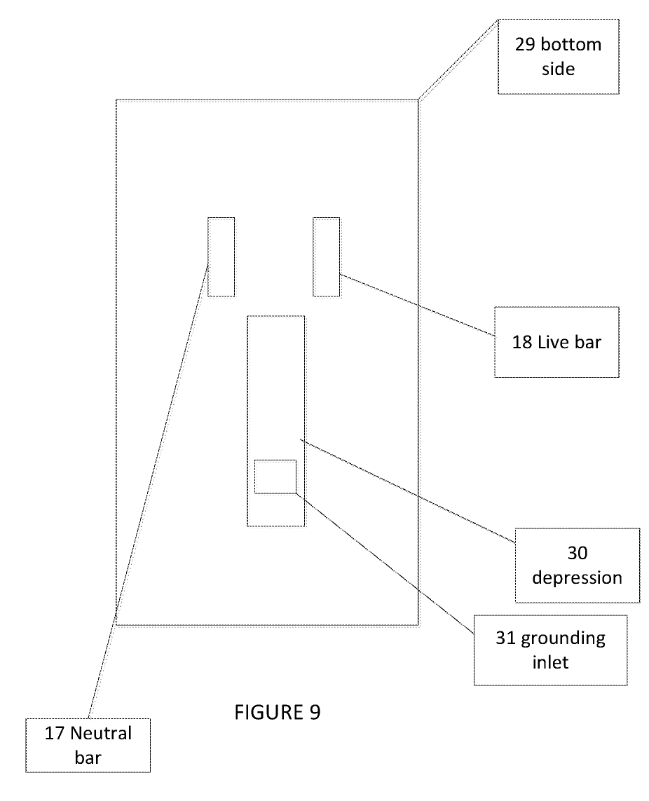

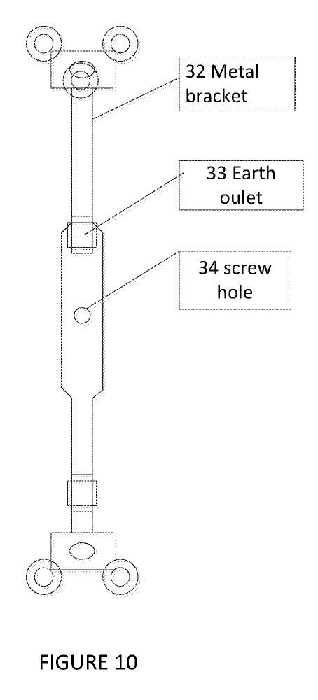

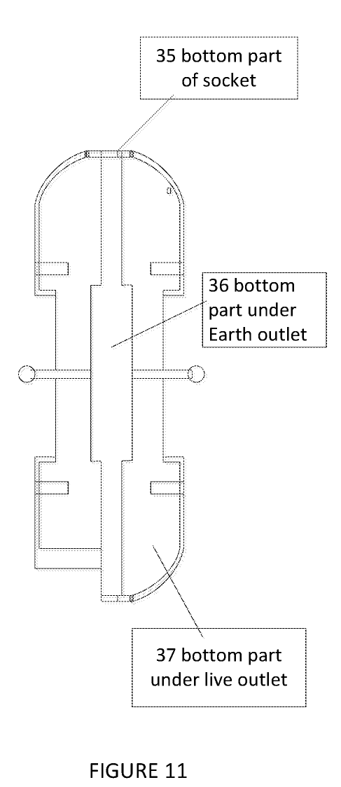

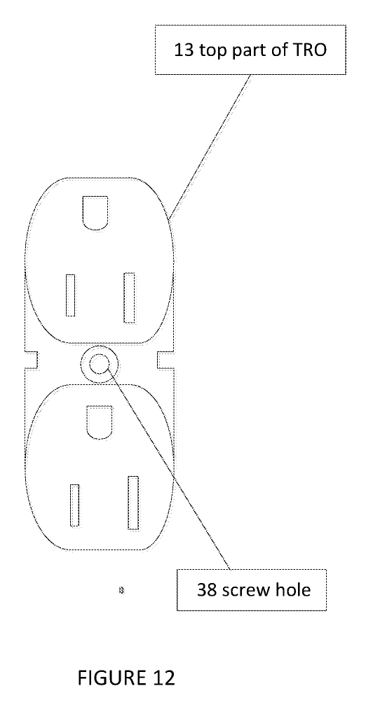

FIG. (9) shows the bottom or plug part (29) of an adapter for NEMA 1 wall socket, it shows the Live (18) and Neutral (17) bars and a depression (30) deep enough to enclose the screw (25) and grounding piece (27) and grounding inlet (31) which may also be circular.

FIG. (10) shows the metal bracket (32) that houses the Earth outlets (33) and secures the socket to the wall and secures the face plate with a screw through a screw hole (34).

FIG. (11) shows the plastic part of the bottom of a wall socket (35) and bottom pars underneath the Earth metal bracket (36) and underneath the live outlet (37).

FIG. (12) shows the top part of TRO (13) and screw hole for the wall plate (38).

### DETAILED DESCRIPTION OF THE INVENTION

The invention is a duplex (2 gang) tamper resistant socket adapter pluggable into a regular wall socket (NEMA 1 or NEMA 5). The plug terminals provide AC power and grounding to the socket outlets. There are basically two embodiments for realizing this invention; each, however, has multiple implementations. For each there are the cases of NEMA 5 (grounded) wall sockets and NEMA 1 (ungrounded wall sockets).

### The First Embodiment

The first embodiment is to design a new, or modify the design of an existing, tamper resistant socket to make it pluggable into regular wall socket. This entails creation of new socket outlets/inlets-plug bar combinations, modifications to plastic enclosure to accommodate the plug bars and their interconnection to the socket outlets. One example of socket outlet-plug bar combination is shown in FIG. (2), the bottom of the plastic housing of the socket is cut to allow the bar through as shown in FIG. (11). Holes are also drilled in the bottom of the plastic housing of the socket to allow for Earth pins of the plug, whether one or two Earth pins are used. In both cases an electrically conducting screw through the screw hole (36) of FIG. (10) driven all the way to the connecting strip (11) of FIGS. (3A & 3B) which also secures the said strip in place in addition to providing electrical connection between the two sets of Earth terminals; those of the socket and those of the plug. FIGS. (4A & 4B) show alternative implementations of the socket outlet-plug bar combination and may include one or more screws to secure them to the plastic body of the adapter. From electrical point of view, it does not make a difference if only one set

Of plug bars and earth pins is inserted in the wall socket or both sets as far the combinations shown in FIG. (2) and FIG. (4A), the latter, however provides better anchoring in the wall socket.

For ungrounded (NEMA 1) wall sockets, the Earth pins are replaced by a grounding metal piece (27) of FIG. (7) which is L shaped with a screw hole (26). This piece uses the screw that secures the plastic face plate to the wall socket and goes through the metal bracket (32) which houses the Earth outlets of the socket as shown in FIG. (10). The screw is first removed and the said grounding piece (27) is placed on top of the face plate and screwed in through the metal bracket thus electrically connecting the said grounding piece (27) to Earth through the said metal bracket (33). The bottom of the adapter for non grounded wall sockets shown in FIG. (9) has a depression in the middle deep enough so that when it is placed over the screw (25) and the grounding piece (27), the length of the plug bars and Earth pins engaged in the wall socket does not change and stay within NEMA standard requirements. Instead of the Earth pins, the adapter for ungrounded wall socket has a grounding contact (28) shown in FIG. (8B). The said contact extends slanted over a grounding inlet (31) shown in FIG. (9) and extending beyond the center so that when the grounding piece (27) is inserted it would push the grounding contact upward and forcing to press against the grounding piece (27) for improved electrical contact. The electrical contact with the Earth of the socket is established through the said metal screw (25), driven all the way and pressing against the connecting strip (11) that also mechanically secures it. Alternately, as shown in FIG. (12), a long metal screw though the screw hole (38) in the top part of the tamper resistant socket (13), the said through hole lines up vertically with the screw hole (34) of the metal bracket (32) in FIG. (10) and the hole (39) in the bottom part of the socket (35) shown in FIG. (13). The faceplate screw (25) is removed and the adapter is plugged into the NEMA 1 wall socket and the long screw is screwed in the metal bracket (32) of the wall socket there by electrically connecting the two Earth connections.

### The Second Embodiment

In this embodiment, an off the shelf tamper resistant socket is used to construct the tamper resistant adapter. The electrical connections between the outlets of the said tamper resistant socket and plug bars and pins can be established via electrically conducting metal connectors (21) in FIG. (5A) and connecting them to the plug terminals (16, 17 and 19). The said connectors (21) also serve as anchors for the said socket and can be simply a printed circuit board PCB making the connections through traces, which in turn is secured to an enclosure (14). In case of NEMA 1 ungrounded socket, can be secured to the said enclosure (21) and connected to the terminals of the tamper resistant socket (12, 15, and 22) using electrical wires without need for a PCB or any other connecting plane. Grounding is achieved using a long screw through the holes (38) and (34) and the wall socket's plate hole (after removing the screw). The said screw will provide anchoring and electrical connection between the adapter's Earth pin (15) and the metal frame of the wall socket. The said metal frame is secured to the grounded metal enclosure in the wall.

What is claimed:

1. An electrical power socket adapter device comprising:
one or more electrical conducting metallic protrusions arranged to plug into and electrically mate with an electrical power receptacle, wherein at least one of the one or more electrical conducting metallic protrusions mate to a live electrical power conductor in the electrical power receptacle;
one or more electrically conductive metallic strips, wherein:
at least one of the one or more metallic strips connect to the live electrical power conductor in the electrical power receptacle,
the at least one of the one or more metallic strips are made from a flat metal piece that is parallel to a reference plane, and
the flat metal piece is stamped and then folded forming one or more lips that protrude away from the reference plane;
an insulating cover that covers the one or more electrically conductive metallic strips disposed between the insulating cover and the electrical receptacle, the insulating cover including one or more slots of a size to receive an electrical plug, wherein the insulating cover physically blocks access to the at least one of the one or more metallic strips that connect to the live electrical power conductor when the electrical plug is not received by the insulating cover, the electrical voltage is provided to the one or more lips of the at least one or more metallic strips, and wherein an electrical voltage is provided to at least one terminal of the electrical plug when the insulating cover receives the electrical plug; and
a mounting part associated with the insulating cover that rigidly attaches the insulating cover to the electrical receptacle.

2. The device of claim 1, wherein the electrical power receptacle is compatible with National Electrical Manufacturers Association (NEMA) standards.

3. The device of claim 2, wherein the electrical receptacle is at least one of a NEMA 1- or a NEMA 5-compatible electrical receptacle.

4. The device of claim 3, wherein the electrical receptacle is a NEMA 1-compatible electrical receptacle and the formed electrically conductive metallic piece provides the ground to a ground contact of the NEMA 1-compatible electrical plug when the insulating cover receives the NEMA 1-compatible electrical plug, thereby adapting the NEMA 1-compatible electrical receptacle to a safety standard.

5. The device of claim 1, wherein the mounting part is a screw that fits through a hole in the insulating cover and screws into a threaded hole in the electrical receptacle.

6. The device of claim 5, wherein the screw connects a ground contact associated with the electrical plug to ground when the electrical plug is received by the insulating cover.

7. The device of claim 6, wherein the ground contact associated with the plug is electrically connected to the ground via a second conductive metallic strip of the one or more metallic strips when the screw is screwed into the threaded hole.

8. The device of claim 5, further comprising a recessed portion for receiving the screw.

9. The device of claim 5, wherein the screw is removable from the electrical receptacle before the one or more electrical conducting metallic protrusions are electrically mated with the electrical power receptacle.

10. The device of claim 9, wherein the mounting part is aligned with a screw hole associated with the screw removed from the electrical receptacle.

11. The device of claim 1, wherein the mounting part is a protrusion extending from the insulating cover in a direction that faces toward the electrical receptacle when the insulating cover is aligned for installation with electrical receptacle, and wherein the protruding part:
passes through a mounting hole in the electrical receptacle when the insulating cover is installed,
rigidly attaches the insulating cover to the electrical receptacle, and
connects a connection associated with the electrical plug to a ground when the electrical plug is received by the insulating cover via a second conductive metallic strip when the protrusion in the insulating cover is received by the mounting hole.

12. The device of claim 1, wherein the at least one of the electrically conductive strips are formed from metal sheets.

13. The device of claim 1, further comprising a neutral contact and a ground contact.

14. The device of claim 1, further comprising a formed electrically conductive metallic piece, wherein the formed electrically connected metallic piece connects to the mounting part and to a ground.

15. The device of claim 1, wherein a printed circuit board includes a trace associated with an electrical connection of the one or more electrically conductive metallic strips.

16. The device of claim 1, wherein a tamper-resistant socket is attached to the insulating cover and the tamper-resistant socket is electrically attached to the one or more electrical conducting metallic protrusions arranged to plug into and electrically mate with the electrical power receptacle.

17. The device of claim 16, further comprising an enclosure that contains at least a portion of the tamper-resistant socket.

18. The device of claim 16, further comprising a printed circuit board that electrically couples the one or more electrical conducting metallic protrusions to the tamper-resistant socket.

19. The device of claim 1, wherein the at least one of the one or more electrical conducting metallic protrusions that mate to the live electrical power conductor in the electrical power receptacle provide provides a live electrical voltage to a contact capable of mating to a second electrical power plug.
